(19) United States
(12) Patent Application Publication
(10) Pub. No.: US 2025/0392676 A1
(43) Pub. Date: Dec. 25, 2025

(54) IMAGE FORMING APPARATUS CAPABLE OF SHORTENING EXECUTION TIME OF ADJUSTMENT PROCESSING FOR ADJUSTING IMAGE FORMING PORTION, AND STORAGE METHOD

(71) Applicant: KYOCERA Document Solutions Inc., Osaka (JP)

(72) Inventor: Shinji Nakatsuka, Osaka (JP)

(21) Appl. No.: 19/236,131

(22) Filed: Jun. 12, 2025

(30) Foreign Application Priority Data
Jun. 21, 2024 (JP) 2024-100381

(51) Int. Cl. H04N 1/405; H04N 1/21

(52) U.S. Cl. CPC H04N 1/405; H04N 1/2104

(57) ABSTRACT

An image forming apparatus is communicably connected to an image generation apparatus which generates halftone image data and includes an image forming portion, an adjustment processing portion, an acquisition processing portion, and a storage processing portion. The image forming portion forms an image based on the halftone image data. The adjustment processing portion executes adjustment processing for adjusting the image forming portion based on a result of reading an adjustment image formed by the image forming portion. The acquisition processing portion acquires adjustment halftone image data that is generated by the image generation apparatus based on original data corresponding to the adjustment image. The storage processing portion stores the adjustment halftone image data acquired by the acquisition processing portion in a storage portion.

### INCORPORATION BY REFERENCE

This application is based upon and claims the benefit of priority from the corresponding Japanese Patent Application No. 2024-100381 filed on Jun. 21, 2024, the entire contents of which are incorporated herein by reference.

### BACKGROUND

The present disclosure relates to an image forming apparatus and a storage method.

An image forming apparatus such as a printer includes an image forming portion which forms an image based on halftone image data. Further, there is known an image forming apparatus which executes adjustment processing for adjusting the image forming portion based on a result of reading a predetermined adjustment image formed by the image forming portion.

Furthermore, the image forming apparatus communicably connected to an external image generation apparatus such as a DFE (Digital Front End) which generates the halftone image data is known.

### SUMMARY

An image forming apparatus according to an aspect of the present disclosure is communicably connected to an image generation apparatus which generates halftone image data and includes an image forming portion, an adjustment processing portion, an acquisition processing portion, and a storage processing portion. The image forming portion forms an image based on the halftone image data. The adjustment processing portion executes adjustment processing for adjusting the image forming portion based on a result of reading a predetermined adjustment image formed by the image forming portion. The acquisition processing portion acquires adjustment halftone image data that is generated by the image generation apparatus based on original data corresponding to the adjustment image. The storage processing portion stores the adjustment halftone image data acquired by the acquisition processing portion in a predetermined storage portion.

A storage method according to another aspect of the present disclosure is executed in an image forming apparatus which is communicably connected to an image generation apparatus which generates halftone image data and includes an image forming portion which forms an image based on the halftone image data, the storage method including an adjustment step, an acquisition step, and a storage step. The adjustment step includes executing adjustment processing for adjusting the image forming portion based on a result of reading a predetermined adjustment image formed by the image forming portion. The acquisition step includes acquiring adjustment halftone image data that is generated by the image generation apparatus based on original data corresponding to the adjustment image. The storage step includes storing the adjustment halftone image data acquired in the acquisition step in a predetermined storage portion.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing a configuration of an image forming system including an image forming apparatus according to an embodiment of the present disclosure;

FIG. 2 is a diagram showing a configuration of an image forming portion of the image forming apparatus according to the embodiment of the present disclosure;

FIG. 3 is a diagram showing an example of an adjustment image formed by the image forming portion of the image forming apparatus according to the embodiment of the present disclosure;

FIG. 4 is a flowchart showing an example of first operation control processing executed by the image forming apparatus according to the embodiment of the present disclosure; and

FIG. 5 is a flowchart showing an example of second operation control processing executed by the image forming apparatus according to the embodiment of the present disclosure.

### DETAILED DESCRIPTION

Hereinafter, an embodiment of the present disclosure will be described with reference to the attached drawings. It is noted that the following embodiment is an example of embodying the present disclosure and does not limit the technical scope of the present disclosure.

### Configuration of Image Forming System 100

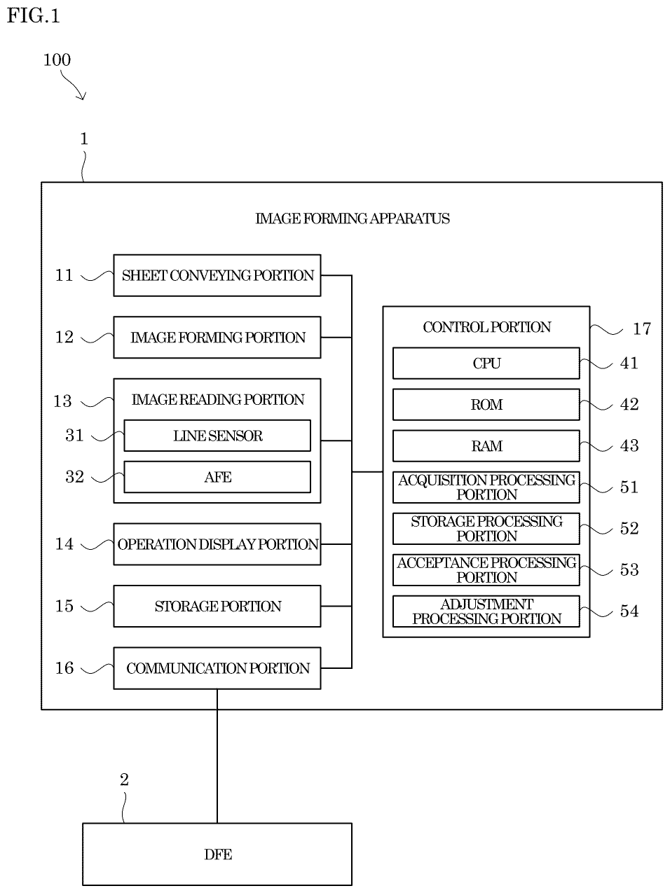

First, a configuration of an image forming system 100 including an image forming apparatus 1 according to the embodiment of the present disclosure will be described with reference to FIG. 1.

As shown in FIG. 1, the image forming system 100 includes the image forming apparatus 1 and a DFE (Digital Front End) 2.

In the image forming system 100, the image forming apparatus 1 and the DFE 2 are communicably connected to each other via a communication network such as a LAN (Local Area Network).

The image forming apparatus 1 is a printer that forms an image on a print medium such as a sheet. For example, the image forming apparatus 1 is a production printer. For example, the image forming apparatus 1 forms an image on a sheet by an inkjet method. It is noted that the print medium may be cloth, a plastic film, or the like.

The DFE 2 is an image processing apparatus that generates halftone image data based on document sheet data to be printed. The image forming apparatus 1 forms an image on a sheet based on the halftone image data generated by the DFE 2. The DFE 2 is an example of an image generation apparatus according to the present disclosure.

Specifically, the DFE 2 executes rasterization processing for changing a data format of the document sheet data into a raster format. The DFE 2 also executes screen processing for generating the halftone image data based on the document sheet data that has been converted into the raster format. For example, the DFE 2 executes AM screen processing for changing a size of halftone dots according to gradation values expressed by the halftone dots, or FM screen processing for changing a density of the halftone dots according to the gradation values expressed by the halftone dots. The content of the screen processing executed by the DFE 2, that is, a method of generating the halftone image data, differs for each type of the DFE 2.

In the image forming system 100, the DFE 2 to be connected to the image forming apparatus 1 is switched in accordance with a type of image included in the document sheet data. Specifically, in the image forming system 100, when the document sheet data is printed, the DFE 2 capable of executing the screen processing having good compatibility with the type of image included in the document sheet data is connected to the image forming apparatus 1.

### Configuration of Image Forming Apparatus 1

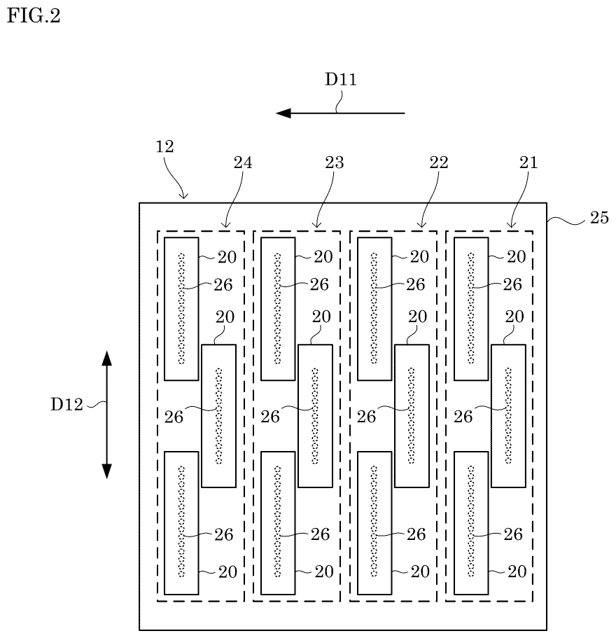

Next, a configuration of the image forming apparatus 1 according to the embodiment of the present disclosure will be described with reference to FIG. 1 and FIG. 2. FIG. 2 is a plan view showing a configuration of an image forming portion 12.

As shown in FIG. 1, the image forming apparatus 1 includes a sheet conveying portion 11, the image forming portion 12, an image reading portion 13, an operation display portion 14, a storage portion 15, a communication portion 16, and a control portion 17.

The sheet conveying portion 11 conveys a sheet stored in a sheet feed cassette (not shown) to a sheet discharge tray (not shown) via an image forming position by the image forming portion 12 and an image reading position by the image reading portion 13. The sheet conveying portion 11 includes a plurality of conveying rollers that are used for conveying the sheet.

The image forming portion 12 forms an image based on the halftone image data. Further, the image forming portion 12 forms an image on a sheet conveyed by the sheet conveying portion 11. As shown in FIG. 2, the image forming portion 12 includes line heads 21 to 24 and a head frame 25.

As shown in FIG. 2, each of the line heads 21 to 24 is elongated in a width direction D12 (see FIG. 2) orthogonal to a sheet conveying direction D11 (see FIG. 2) by the sheet conveying portion 11. Specifically, each of the line heads 21 to 24 has, in the width direction D12, a length corresponding to a width of a sheet of a maximum size out of the sheets that can be stored in the sheet feed cassette. The line heads 21 to 24 are arranged at regular intervals along the conveying direction D11.

The line head 21 ejects black ink toward the sheet conveyed by the sheet conveying portion 11. The line head 22 ejects cyan ink toward the sheet conveyed by the sheet conveying portion 11. The line head 23 ejects magenta ink toward the sheet conveyed by the sheet conveying portion 11. The line head 24 ejects yellow ink toward the sheet conveyed by the sheet conveying portion 11.

The line heads 22 to 24 have a common configuration with the line head 21 except that the colors of ink to be ejected differ. Hereinafter, descriptions will only be given on the line head 21.

As shown in FIG. 2, the line head 21 includes three recording heads 20. Each of the recording heads 20 is elongated in the width direction D12. The three recording heads 20 are arranged in a staggered pattern along the width direction D12.

A plurality of nozzles 26 (see FIG. 2) are provided on an opposing surface of each of the recording heads 20 that opposes the sheet. In each of the recording heads 20, the plurality of nozzles 26 are arranged along the width direction D12. Specifically, in each of the recording heads 20, the plurality of nozzles 26 are arranged along the width direction D12 at a density corresponding to a printing resolution of the image forming apparatus 1. For example, the plurality of nozzles 26 are arranged at regular intervals along the width direction D12. In other words, each of the recording heads 20 includes a nozzle row formed by the plurality of nozzles 26 arranged at regular intervals along the width direction D12. It is noted that each of the recording heads 20 may include a plurality of nozzle rows.

All of the nozzles 26 included in the line head 21 are arranged along the width direction D12. Specifically, the three recording heads 20 included in the line head 21 are arranged in a staggered pattern along the width direction D12 so that all of the nozzles 26 included in the line head 21 are arranged along the width direction D12 at a density corresponding to the printing resolution of the image forming apparatus 1. The line head 21 ejects ink from each of the nozzles 26 based on the halftone image data.

Further, each of the recording heads 20 includes pressurization chambers (not shown), ejection elements (not shown), and individual flow paths (not shown) that respectively correspond to the nozzles 26. The pressurization chamber is in communication with the nozzle 26 and stores ink. The ejection element causes the ink to be ejected from the nozzle 26 in accordance with an input of a driving signal. For example, the ejection element is a piezoelectric element. The ejection element varies a pressure of the pressurization chamber in accordance with an input of the driving signal, to thus cause the ink to be ejected from the nozzle 26. The individual flow path is an ink flow path provided between the pressurization chamber and a common flow path (not shown) common to the plurality of nozzles 26. The plurality of individual flow paths respectively corresponding to the plurality of nozzles 26 are connected to the common flow path. The common flow path is connected to ink supply portions (not shown) that respectively supply ink to the pressurization chambers.

The head frame 25 supports the line heads 21 to 24. The head frame 25 is supported by a housing of the image forming apparatus 1. It is noted that the number of line heads to be provided in the image forming portion 12 only needs to be one or more. Furthermore, the number of recording heads 20 to be provided in each of the line heads 21 to 24 does not need to be limited to three.

The image reading portion 13 reads an image formed on the sheet by the image forming portion 12.

As shown in FIG. 1, the image reading portion 13 includes a line sensor 31 and an AFE (Analog Front End) 32.

The line sensor 31 is provided more on a downstream side of the conveying direction D11 than the image forming portion 12 (see FIG. 2). The line sensor 31 is capable of reading an image corresponding to one line along a main scanning direction that is the same direction as the width direction D12 (see FIG. 2), from the sheet conveyed by the sheet conveying portion 11. For example, the line sensor 31 is a CIS (Contact Image Sensor). The line sensor 31 includes a plurality of image pickup elements arranged next to one another in the width direction D12. Each of the image pickup elements includes a light-emitting portion and a light-receiving portion. The light-emitting portion emits light toward the sheet conveyed by the sheet conveying portion 11. The light-receiving portion is provided so as to be capable of receiving light that is emitted from the light-emitting portion and reflected by the sheet, and outputs an analog electric signal corresponding to an amount of received light. In response to a control signal input from the control portion 17, the line sensor 31 outputs an analog electric signal corresponding to an image of one line along the main scanning direction at predetermined intervals.

The AFE 32 is an electronic circuit that executes predetermined processing on the analog electric signal output from the line sensor 31. Specifically, the AFE 32 includes a signal conversion portion that converts the analog electric signal output from the line sensor 31 into a digital electric signal (image data). The AFE 32 also includes an image processing portion that executes predetermined image processing such as shading correction on the image data output from the signal conversion portion. The AFE 32 outputs image data obtained after executing the image processing, which is output from the image processing portion, to the control portion 17.

The operation display portion 14 is a user interface of the image forming apparatus 1. The operation display portion 14 includes a display portion and an operation portion. The display portion displays various types of information in response to control instructions from the control portion 17. For example, the display portion is a liquid crystal display. The operation portion is used to input various types of information to the control portion 17 according to user operations. For example, the operation portion includes a touch panel and operation keys.

The storage portion 15 is a nonvolatile storage device. For example, the storage portion 15 is a nonvolatile memory such as a flash memory.

The communication portion 16 is a communication interface that executes wired or wireless data communication with an external communication apparatus such as the DFE 2 via the communication network.

The control portion 17 collectively controls the image forming apparatus 1. As shown in FIG. 1, the control portion 17 includes a CPU 41, a ROM 42, and a RAM 43. The CPU 41 is a processor that executes various types of arithmetic processing. The ROM 42 is a nonvolatile storage device in which information such as control programs for causing the CPU 41 to execute various types of processing is stored in advance. The RAM 43 is a volatile or nonvolatile storage device that is used as a temporary storage memory (working area) for the various type of processing to be executed by the CPU 41. The CPU 41 executes the various control programs stored in advance in the ROM 42. Thus, the control portion 17 collectively controls the image forming apparatus 1.

In the image forming apparatus 1, adjustment processing for adjusting the image forming portion 12 based on a result of reading a predetermined adjustment image formed by the image forming portion 12 is executed.

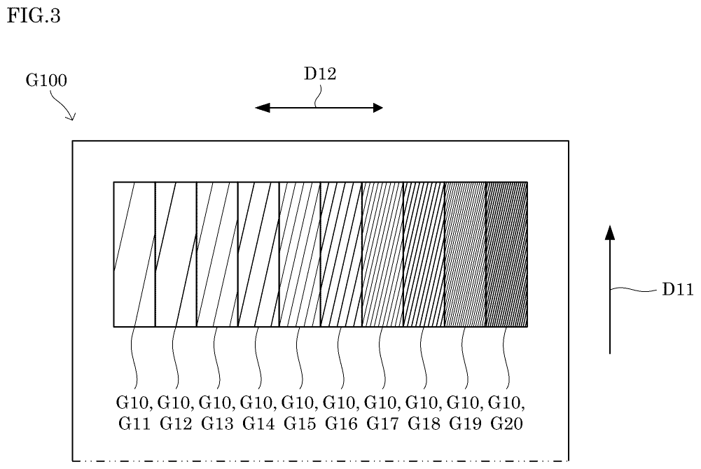

For example, in the adjustment processing, an adjustment image G100 as shown in FIG. 3 is formed. FIG. 3 is a diagram showing the adjustment image G100 formed on the sheet by the image forming portion 12.

The adjustment image G100 is an image formed by the line head 21 of the image forming portion 12. In other words, the adjustment image G100 is an image formed using black ink.

As shown in FIG. 3, the adjustment image G100 includes ten color regions G10 (G11 to G20) having different black concentrations. The color of each of the color regions G10 is expressed by black halftone dots.

The color region G11 is a region with a lowest black concentration out of the ten color regions G10. The color region G12 is a region with the second lowest black concentration out of the ten color regions G10. The color region G13 is a region with the third lowest black concentration out of the ten color regions G10. The color region G14 is a region with the fourth lowest black concentration out of the ten color regions G10. The color region G15 is a region with the fifth lowest black concentration out of the ten color regions G10. The color region G16 is a region with the sixth lowest black concentration out of the ten color regions G10. The color region G17 is a region with the seventh lowest black concentration out of the ten color regions G10. The color region G18 is a region with the eighth lowest black concentration out of the ten color regions G10. The color region G19 is a region with the ninth lowest black concentration out of the ten color regions G10. The color region G20 is a region with the highest black concentration out of the ten color regions G10.

In the adjustment processing, the image reading portion 13 is used to read the adjustment image G100 formed on the sheet. Then, in the adjustment processing, an amount of ink to be ejected by the line head 21 is adjusted based on a result of reading the adjustment image G100 by the image reading portion 13.

For example, in the adjustment processing, the amount of ink to be ejected by each of the nozzles 26 included in the line head 21 is adjusted so that the concentration of each of the color regions G10 formed by the line head 21 becomes a predetermined target value. For example, in the adjustment processing, a voltage or waveform of the driving signal input to the ejection elements respectively corresponding to the nozzles 26 is adjusted to thus adjust the amount of ink to be ejected by each of the nozzles 26.

It is noted that the adjustment image G100 may be an image formed by any of the line heads 22 to 24. Alternatively, in the adjustment processing, four adjustment images G100 respectively corresponding to black, cyan, magenta, and yellow may be formed. In this case, the amount of ink to be ejected by each of the line heads 21 to 24 only needs to be adjusted based on the result of reading the adjustment images G100.

Incidentally, in a conventional image forming apparatus communicably connected to the DFE 2, processing of acquiring the halftone image data corresponding to the adjustment image from the DFE 2 is executed every time the adjustment processing is executed.

In contrast, in the image forming apparatus 1 according to the embodiment of the present disclosure, it is possible to shorten an execution time of the adjustment processing for adjusting the image forming portion 12 as will be described below.

### Functional Configuration of Control Portion 17

Next, a functional configuration of the control portion 17 will be described with reference to FIG. 1.

As shown in FIG. 1, the control portion 17 includes an acquisition processing portion 51, a storage processing portion 52, an acceptance processing portion 53, and an adjustment processing portion 54.

Specifically, an operation control program for causing the CPU 41 to function as the respective processing portions described above is stored in advance in the ROM 42 of the control portion 17. Then, the CPU 41 executes the operation control program stored in the ROM 42 to function as the respective processing portions described above.

It is noted that the operation control program may be recorded on a computer-readable recording medium such as a CD, a DVD, or a flash memory and read from the recording medium to be installed in a storage device such as the storage portion 15. Further, some or all of the processing portions included in the control portion 17 may be constituted of an electronic circuit. Alternatively, the operation control program may be a program for causing a plurality of processors to function as the respective processing portions included in the control portion 17.

The acquisition processing portion 51 acquires adjustment halftone image data that is generated by the DFE 2 based on original data corresponding to the adjustment image G100.

For example, in the image forming apparatus 1, the original data is stored in advance in the storage portion 15. For example, the original data is image data in a raster format.

For example, when the adjustment processing is executed and the adjustment halftone image data associated with identification information of the DFE 2 connected to the image forming apparatus 1 is not stored in the storage portion 15, the acquisition processing portion 51 acquires the adjustment halftone image data generated by the DFE 2. For example, the identification information is a MAC address of the DFE 2. It is noted that the identification information may alternatively be information that is used to identify the type of the DFE 2 (the type of the screen processing to be executed by the DFE 2).

Specifically, when the adjustment processing is executed and the adjustment halftone image data associated with the identification information of the DFE 2 connected to the image forming apparatus 1 is not stored in the storage portion 15, the acquisition processing portion 51 transmits the original data to the DFE 2 and requests the DFE 2 to transmit the adjustment halftone image data that is generated based on the original data. Then, the acquisition processing portion 51 receives the adjustment halftone image data transmitted from the DFE 2 in response to the request from the acquisition processing portion 51.

The storage processing portion 52 stores the adjustment halftone image data acquired by the acquisition processing portion 51 in the storage portion 15.

For example, the storage processing portion 52 stores, in the storage portion 15, the adjustment halftone image data associated with the identification information of the DFE 2 as a generation source.

The acceptance processing portion 53 accepts a selection operation for selecting the adjustment halftone image data stored in the storage portion 15.

For example, the acceptance processing portion 53 causes the operation display portion 14 to display a selection screen that is used to accept the selection operation in accordance with a predetermined user operation made on the operation display portion 14. The selection screen displays each piece of the adjustment halftone image data stored in the storage portion 15 in a selectable manner. For example, the selection screen displays icon images respectively corresponding to the adjustment halftone image data stored in the storage portion 15 in a selectable manner. For example, the icon image include a character string image indicating a data name of the adjustment halftone image data and a character string image indicating an apparatus name of the DFE 2 associated with the adjustment halftone image data.

The adjustment processing portion 54 executes the adjustment processing.

For example, the adjustment processing portion 54 executes the adjustment processing when an instruction to execute the adjustment processing is input via the DFE 2 from an external information processing apparatus that inputs a print job for printing the document sheet data to the image forming system 100.

Furthermore, when the selection operation is accepted by the acceptance processing portion 53, the adjustment processing portion 54 executes the adjustment processing using the adjustment halftone image data selected by the selection operation.

Hereinafter, a storage method according to the present disclosure will be described along with exemplary procedures of respective processing executed by the control portion 17.

### First Operation Control Processing

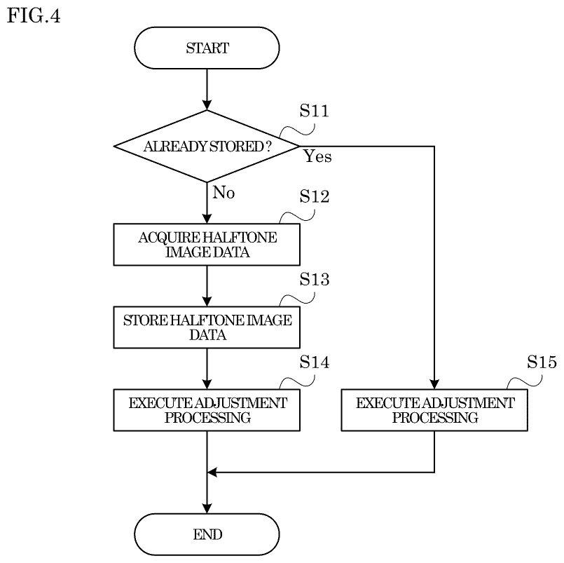

Hereinafter, exemplary procedures of first operation control processing executed by the control portion 17 in the image forming apparatus 1 will be described with reference to FIG. 4. Herein, Step S11, Step S12, . . . represent numbers of processing procedures (steps) executed by the control portion 17. It is noted that the first operation control processing is executed when an instruction to execute the adjustment processing is input from the external information processing apparatus via the DFE 2.

### Step S11

First, in Step S11, the control portion 17 determines whether or not the adjustment halftone image data associated with the identification information of the DFE 2 connected to the image forming apparatus 1 is stored in the storage portion 15.

Herein, when determining that the adjustment halftone image data associated with the identification information of the DFE 2 connected to the image forming apparatus 1 is stored in the storage portion 15 (Yes in S11), the control portion 17 shifts the processing to Step S15. On the other hand, when determining that the adjustment halftone image data associated with the identification information of the DFE 2 connected to the image forming apparatus 1 is not stored in the storage portion 15 (No in S11), the control portion 17 shifts the processing to Step S12.

### Step S12

In Step S12, the control portion 17 acquires the adjustment halftone image data generated by the DFE 2 connected to the image forming apparatus 1. The processing of Step S12 is an example of an acquisition step according to the present disclosure and is executed by the acquisition processing portion 51 of the control portion 17.

Specifically, the control portion 17 transmits the original data to the DFE 2 and requests the DFE 2 to transmit the adjustment halftone image data that is generated based on the original data. Then, the control portion 17 receives the adjustment halftone image data transmitted from the DFE 2 in response to the request from the control portion 17.

### Step S13

In Step S13, the control portion 17 stores the adjustment halftone image data acquired by the processing of Step S12 in the storage portion 15. The processing of Step S13 is an example of a storage step according to the present disclosure and is executed by the storage processing portion 52 of the control portion 17.

Specifically, the control portion 17 associates the adjustment halftone image data acquired by the processing of Step S12 with the identification information of the DFE 2 as the generation source of the adjustment halftone image data. Then, the control portion 17 stores, in the storage portion 15, the adjustment halftone image data associated with the identification information of the DFE 2 as the generation source.

### Step S14

In Step S14, the control portion 17 executes the adjustment processing using the adjustment halftone image data acquired by the processing of Step S12. The processing of Step S14 is an example of an adjustment step according to the present disclosure and is executed by the adjustment processing portion 54 of the control portion 17.

Specifically, the control portion 17 uses the image forming portion 12 to form the adjustment image G100 that is based on the adjustment halftone image data acquired by the processing of Step S12 on a sheet. The control portion 17 also uses the image reading portion 13 to read the adjustment image G100 formed on the sheet. The control portion 17 then adjusts the amount of ink to be ejected by the line head 21 of the image forming portion 12 based on the result of reading the adjustment image G100. It is noted that in the adjustment processing, it is also possible to form an image different from the adjustment image G100 on a sheet so that ink ejection timings of the line heads 21 to 24 and the like are adjusted based on a result of reading the different image.

### Step S15

In Step S15, the control portion 17 executes the adjustment processing using the adjustment halftone image data associated with the identification information of the DFE 2 connected to the image forming apparatus 1, which is stored in the storage portion 15. The processing of Step S15 is an example of an adjustment step according to the present disclosure and is executed by the adjustment processing portion 54 of the control portion 17.

### Second Operation Control Processing

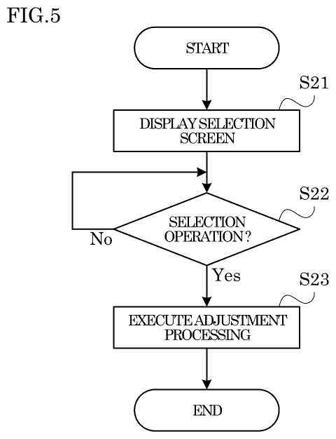

Next, exemplary procedures of second operation control processing executed by the control portion 17 in the image forming apparatus 1 will be described with reference to FIG. 5. It is noted that the second operation control processing is executed when a user operation that instructs to execute the second operation control processing is accepted in the operation display portion 14.

### Step S21

First, in Step S21, the control portion 17 causes the operation display portion 14 to display the selection screen. The processing of Step S21 is executed by the acceptance processing portion 53 of the control portion 17.

### Step S22

In Step S22, the control portion 17 determines whether or not the selection operation has been accepted in the selection screen displayed by the processing of Step S21.

Herein, when determining that the selection operation has been accepted (Yes in S22), the control portion 17 shifts the processing to Step S23. On the other hand, when determining that the selection operation has not been accepted (No in S22), the control portion 17 waits for the acceptance of the selection operation in Step S22.

### Step S23

In Step S23, the control portion 17 executes the adjustment processing using the adjustment halftone image data selected by the selection operation. The processing of Step S23 is an example of the adjustment step according to the present disclosure and is executed by the adjustment processing portion 54 of the control portion 17.

In this manner, in the image forming apparatus 1, when the adjustment processing is executed and the adjustment halftone image data associated with the identification information of the DFE 2 connected to the image forming apparatus 1 is not stored in the storage portion 15, the adjustment halftone image data is acquired from the DFE 2, and the acquired adjustment halftone image data is stored in the storage portion 15. Thus, when the adjustment processing is executed and the adjustment halftone image data associated with the identification information of the DFE 2 connected to the image forming apparatus 1 is stored in the storage portion 15, it is possible to execute the adjustment processing using the adjustment halftone image data. In other words, it is possible to omit the processing of acquiring the adjustment halftone image data from the DFE 2. Therefore, it is possible to shorten the execution time of the adjustment processing.

Furthermore, in the image forming apparatus 1, when the selection operation is accepted, the adjustment processing is executed using the adjustment halftone image data selected by the selection operation. Thus, the image forming apparatus 1 can execute the adjustment processing even in a state where the DFE 2 is not connected.

It is noted that when the image forming apparatus 1 is connected to the DFE 2 and the adjustment halftone image data associated with the identification information of the DFE 2 is not stored in the storage portion 15, the acquisition processing portion 51 may acquire the adjustment halftone image data generated by the DFE 2. In other words, the acquisition processing portion 51 may acquire the adjustment halftone image data generated by the DFE 2 at a timing when the DFE 2 that has never been connected is connected to the image forming apparatus 1.

Further, the storage processing portion 52 may store the adjustment halftone image data acquired by the acquisition processing portion 51 in a storage device outside the image forming apparatus 1.

Furthermore, the image forming apparatus 1 may form an image using an image forming method different from the inkjet method, such as electrophotography.

### Notes of Disclosure

Hereinafter, a general outline of the disclosure extracted from the embodiment described above will be noted. It is noted that the respective configurations and processing functions described in the notes below can be sorted and arbitrarily combined as appropriate.

### Note 1

An image forming apparatus communicably connected to an image generation apparatus which generates halftone image data, including: an image forming portion which forms an image based on the halftone image data; an adjustment processing portion which executes adjustment processing for adjusting the image forming portion based on a result of reading a predetermined adjustment image formed by the image forming portion; an acquisition processing portion which acquires adjustment halftone image data that is generated by the image generation apparatus based on original data corresponding to the adjustment image; and a storage processing portion which stores the adjustment halftone image data acquired by the acquisition processing portion in a predetermined storage portion.

### Note 2

The image forming apparatus according to note 1, in which the storage processing portion stores, in the storage portion, the adjustment halftone image data associated with identification information of the image generation apparatus as a generation source.

### Note 3

The image forming apparatus according to note 2, in which the acquisition processing portion acquires the adjustment halftone image data generated by the image generation apparatus when the adjustment processing is executed and the adjustment halftone image data associated with the identification information of the image generation apparatus connected to the image forming apparatus is not stored in the storage portion.

### Note 4

The image forming apparatus according to note 2, in which the acquisition processing portion acquires the adjustment halftone image data generated by the image generation apparatus when the image forming apparatus is connected to the image generation apparatus and the adjustment halftone image data associated with the identification information of the image generation apparatus is not stored in the storage portion.

### Note 5

The image forming apparatus according to any one of notes 1 to 4, including: an acceptance processing portion which accepts a selection operation for selecting the adjustment halftone image data stored in the storage portion, in which the adjustment processing portion executes the adjustment processing using the adjustment halftone image data selected by the selection operation.

### Note 6

A storage method executed in an image forming apparatus which is communicably connected to an image generation apparatus which generates halftone image data and includes an image forming portion which forms an image based on the halftone image data, the storage method including: an adjustment step of executing adjustment processing for adjusting the image forming portion based on a result of reading a predetermined adjustment image formed by the image forming portion; an acquisition step of acquiring adjustment halftone image data that is generated by the image generation apparatus based on original data corresponding to the adjustment image; and a storage step of storing the adjustment halftone image data acquired in the acquisition step in a predetermined storage portion.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus communicably connected to an image generation apparatus which generates halftone image data, comprising:
an image forming portion which forms an image based on the halftone image data;
an adjustment processing portion which executes adjustment processing for adjusting the image forming portion based on a result of reading a predetermined adjustment image formed by the image forming portion;
an acquisition processing portion which acquires adjustment halftone image data that is generated by the image generation apparatus based on original data corresponding to the adjustment image; and
a storage processing portion which stores the adjustment halftone image data acquired by the acquisition processing portion in a predetermined storage portion.

2. The image forming apparatus according to claim 1, wherein
the storage processing portion stores, in the storage portion, the adjustment halftone image data associated with identification information of the image generation apparatus as a generation source.

3. The image forming apparatus according to claim 2, wherein
the acquisition processing portion acquires the adjustment halftone image data generated by the image generation apparatus when the adjustment processing is executed and the adjustment halftone image data associated with the identification information of the image generation apparatus connected to the image forming apparatus is not stored in the storage portion.

4. The image forming apparatus according to claim 2, wherein
the acquisition processing portion acquires the adjustment halftone image data generated by the image generation apparatus when the image forming apparatus is connected to the image generation apparatus and the adjustment halftone image data associated with the identification information of the image generation apparatus is not stored in the storage portion.

5. The image forming apparatus according to claim 1, comprising:
an acceptance processing portion which accepts a selection operation for selecting the adjustment halftone image data stored in the storage portion, wherein
the adjustment processing portion executes the adjustment processing using the adjustment halftone image data selected by the selection operation.

6. A storage method executed in an image forming apparatus which is communicably connected to an image generation apparatus which generates halftone image data and includes an image forming portion which forms an image based on the halftone image data, the storage method comprising:
an adjustment step of executing adjustment processing for adjusting the image forming portion based on a result of reading a predetermined adjustment image formed by the image forming portion;
an acquisition step of acquiring adjustment halftone image data that is generated by the image generation apparatus based on original data corresponding to the adjustment image; and
a storage step of storing the adjustment halftone image data acquired in the acquisition step in a predetermined storage portion.
